(19) United States
(12) Patent Application Publication
(10) Pub. No.: US 2011/0106677 A1
(43) Pub. Date: May 5, 2011

(54) SYSTEM AND METHOD OF OFFSETTING INVOICE OBLIGATIONS

(76) Inventor: Samer ElBizri, Los Angeles, CA (US)

(21) Appl. No.: 12/899,344

(22) Filed: Oct. 6, 2010

Related U.S. Application Data
(63) Continuation-in-part of application No. 12/188,875, filed on Aug. 8, 2008.

(30) Foreign Application Priority Data
Aug. 8, 2008 (US) PCT/US2008/072691

(51) Int. Cl. G06Q 30/00

(52) U.S. Cl. 705/30

(57) ABSTRACT

Invoice resolution systems are disclosed that include: at least one sales invoice, wherein each sales invoice comprises a credit value, at least one purchase invoice, wherein each purchase invoice comprises a debit value, at least one database or repository stored on a medium for executing the executable code that collects the at least one sales invoice and the at least one purchase invoice; and an executable code for intelligently determining an invoice chain comprising at least one purchase invoice having a debit value and at least one sales invoice having a credit value and offsetting the debit value with the credit value. Invoice resolution systems are also disclosed that include: at least one sales invoice, wherein each sales invoice comprises a credit value, at least one purchase invoice, wherein each purchase invoice comprises a debit value, at least one database or repository stored on a network computer system that collects the at least one sales invoice and the at least one purchase invoice; and an executable code for intelligently sorting the at least one purchase invoice having a debit value and at least one sales invoice having a credit value to produce an invoice chain and offsetting the debit value with the credit value. Methods for resolving invoice obligations include: providing at least one seller having at least one sales invoice, providing at least one customer having at least one sales invoice and at least one purchase invoice, producing an invoice chain by utilizing the at least one sales invoice and at least one of the at least one purchase invoice; and offsetting the at least one sales invoice of the seller with at least one sales invoice of the customer, at least one purchase invoice or a combination thereof.

This application is a United States Continuation in Part Application that claims priority to U.S. Provisional Application Ser. No. 60/955,364 filed on Aug. 12, 2007, PCT Application Serial No.: PCT/US08/72691 and United States Utility Application Serial No. 12/188,875 filed on Aug. 8, 2008, which are all commonly-owned and incorporated herein in its entirety by reference.

### FIELD OF THE SUBJECT MATTER

The field of the subject matter is the transformation of invoice obligations, such as paper invoices, factoring paperwork, currency and other related documents and paperwork into electronic form, the offsetting and payment of these invoice obligations and the systems, software and methods utilized to complete those offsetting transactions.

### BACKGROUND

Business, commercial, government and non-profit entities or individuals issue invoices to customers for products or services sold. These invoices include an amount owed for such products and services, and most may include the quantities of those products and services and the stated or agreed upon prices or fares among other terms. Indebtedness includes all obligations for payment, borrowed money, lease obligations, taxes or other forms of indebtedness. Such obligations may be among all type of entities including multiple financial institutions or entities serviced through one or more financial institution. Government entities also issue invoices for services and/or indebtedness, asset sales, tariffs, interest, taxes and penalties to individual and business taxpayers. Products and services may also include interest, loan principal and penalties. These business, commercial, government and non-profit entities and/or individuals that issue invoices are herein collectively referred to as “sellers”.

Sellers routinely have a large amount of their assets in account receivables or unpaid invoices that these sellers have issued to customers for payment but have not been paid yet. Although the current batch of invoices may be paid within a reasonable amount of time—say 30-90 days—by the time these invoices are paid, new invoices would have been issued. This process and the times it takes customers to pay leave sellers with a reduced level of capital (reduced liquidity) and free assets to conduct business.

In order to increase the level of available cash for business purposes (including mainly paying obligations to others), sellers will routinely discount their receivables (sales invoices), borrow money or utilize other financial methods, such as factoring, issuing short term notes or receivable financing. While these processes are available to credit qualified businesses, related discounts, interest and transaction costs can significantly affect the cost of doing business, growth and profit margins for a business. Although these processes are not desired by businesses, currently there are no effective alternatives that offer decreased costs and expenses.

Many sellers discount their receivables in order to entice customers to pay early. Although this strategy is effective some of the time, it is quite costly to sellers (average of about 2% per invoice). Some sellers can be qualified to finance their sales invoices at interest rates that correspond to creditworthiness and ranging on average from 1% below to 11% above prime rate. Some sellers factor (sell) their sales invoices at an average cost of 1% to 4% of the sales invoice credit value depending on terms and receive about 70% to 90% of that credit value upfront with the balance less factoring fees and expenses at the time until the customer pays.

Some sellers incorporate the cost of interest, transaction costs and penalties in their invoices and pass it on to their customers, which increase the liability and costs to these customers and reduce the seller's price competitiveness. Some sellers write these additional costs off without passing them along to customers, in order to maintain good working relationships at the cost of lower profit margins. As used herein, the term “customer” means any person or entity that receives an invoice for payment. As used herein, the term “payment” means any exchange of money or equivalent asset to clear an amount of an invoice debit value and obligations. This process is shown in Prior Art FIG. 1, which shows conventional methods of invoice payment and financing.

In Prior Art FIG. 1, a process 100 is shown between a seller 110 and a customer 120. The seller 110 sells goods or services 130 and the customer 120 makes payments within 30 to 90 days 140. After 30 to 90 days, the cycle 150 repeats between the seller 110 and its customers 120. An average of 8% to 15% of a seller's 110 annual revenues is contractually locked in unpaid sales invoices 160. In order to get cash, the seller 110 can discount the sales invoice 170 to entice the customer 120 to pay early; sell invoices to a factoring firm, or borrow money from a bank or by issuing debt instruments in the capital markets.

As a reference point for the subject matter disclosed herein, the factoring market in the United States exceeded $127 billion in outstanding factored receivables (sales invoices) in 2006. In 2006, the asset-based lending market exceeds $480 billion and around $2 trillion in outstanding commercial papers in the United States. Today, banks in the US transact $135 trillion in payments annually, with the vast majority in commercial and public business transactions. These numbers are growing, coupled with recent financial downturn in various sectors, means that additional invoices are left unpaid, financing options are increasingly limited and so is availability of factoring capital. Meanwhile, constrained liquidity and high credit risk on business loans limit banks' abilities to lend and further prohibits them from being able to expand in certain business industry sectors in the economy. For example, the average large bank in the US needs to risk upward of $33 billion a year to generate $1 billion in interest income.

There do not appear to be any current procedures, methods or systems for resolving invoice obligations of multiple sellers, multiple customers, including banks and financial institutions, and multiple invoices at the same time or in an intelligent manner to quickly produce invoice chains and offset invoices for as many related parties as possible. U.S. Pat. No. 6,910,021 issued to Brown et al. in 2005 describes a financial management system that supports offsetting programs, but does not actually complete the offsetting process. The United States Treasury has set up a trial offsetting system whereby refunds that are owed to a taxpayer are offset by any past due judgments or family/child support payments owed by that same taxpayer. There do not appear to be any current procedures methods or systems though for matching up sellers and customers to offset their invoice obligations without making a payment drawn from a bank, credit or investment account (with extremely limited and inefficient exceptions of bartering or payment forgiveness). US 2005/0086165 published to Pawelczyk et al. entitled “Systems and Methods for Intraday Netting Payment Finality With Supplemental Funding” discloses systems and methods for “continuous intraday final settlement of payment orders” among numerous participants. The invention requires that the participant(s) deposit a predetermined amount of money into a prefunded balance account and then send messages to other participants regarding various specific obligations. The obligations are settled at the end of each day, and the offsets in this system are planned and directed as offsets by the participants to other specific and known participants. The offsets are not automatically generated on the basis of other considerations.

The benefits from offsetting purchase invoice debits with sales invoice credits has also processing benefits beyond the payment process. The printing, mailing, faxing, shipping, processing of purchase and sales invoices, if automated, will significantly reduce the processing costs of sellers and buyers. Additionally, such automation will replace paper processes with electronic and automated methods.

Based on the current process of issuing and paying invoices whether on paper or electronically, between sellers and customers, it would be economically helpful and desirable to produce a new system and related methods for matching a seller's invoices and offsetting its purchase invoices with its sales invoices by linking its invoices with those of its customers and its sellers (vendors) and their customers and sellers in order to offset invoice debit and credit values, to reduce payment times, to reduce the number of outstanding invoices, to reduce invoice discount costs, penalties, interest, and the need to borrow or finance assets, to increase available credit and buying power or a combination thereof.

### BRIEF DESCRIPTION OF THE FIGURES

Prior Art FIG. 1 shows an invoice diagram that shows conventional methods of invoice payment and financing.

FIG. 2 shows a chain of invoices with linked credits and debits among multiple sellers (who are also customers) develops (which is described in detail in Example 2).

In FIG. 3, a contemplated system, which may be referred to as the Invoice Clearing System, looks for specific relationships and matching characteristics between sales invoices issued by different sellers and uses these relationships to offset invoice obligations and clear them.

FIG. 4 shows a block diagram for a contemplated system, where a contemplated workflow of invoices in a computer-based network environment is described.

FIG. 5 shows an example of an incomplete invoice chain or a disparity chain.

FIG. 6 shows an example of an incomplete chain with 10 sellers and customers (i.e. “Company A” through customer “Company J”) and a cash payment made by the forth customer (in this chain the forth customer is the same as the sixth seller, “Company D”).

FIG. 7 shows a contemplated flow of payments and netting.

FIG. 8 shows the results of the payments and netting from FIG. 7.

### SUMMARY

Invoice resolution systems are disclosed that include: at least one sales invoice, wherein each sales invoice comprises a credit value, at least one purchase invoice, wherein each purchase invoice comprises a debit value, at least one database or repository stored on a medium for executing the executable code that collects the at least one sales invoice and the at least one purchase invoice; and an executable code for intelligently determining an invoice chain comprising at least one purchase invoice having a debit value and at least one sales invoice having a credit value and offsetting the debit value with the credit value. The sales invoice and the purchase invoice are two separate invoices involving at least one party that is the beneficiary of one invoice (invoice issued by that beneficiary) and at least one party that is the payor of the other invoice (invoice issued to that payor). For example, in one embodiment, the sales invoice and the purchase invoice each involve two parties (a seller and a buyer) whereas in at least the seller in the sales invoice is the same as the buyer in the purchase invoice.

Invoice resolution systems are also disclosed that include: at least one sales invoice, wherein each sales invoice comprises a credit value, at least one purchase invoice, wherein each purchase invoice comprises a debit value, at least one database or repository stored on a networked computer system that collects the at least one sales invoice and the at least one purchase invoice; and an executable code for intelligently sorting the at least one purchase invoice having a debit value and at least one sales invoice having a credit value to produce an invoice chain and offsetting the debit value with the credit value.

Invoice resolution systems are also disclosed that include: at least one electronic sales invoice, wherein each sales invoice comprises a credit value, at least one electronic purchase invoice, wherein each purchase invoice comprises a debit value, at least one database stored on a network computer system that collects the at least one electronic sales invoice and the at least one electronic purchase invoice; and an executable code for intelligently sorting the at least one electronic purchase invoice having a debit value and at least one electronic sales invoice having a credit value to produce an invoice chain and offsetting the debit value with the credit value.

Methods for resolving invoice obligations include: providing at least one seller having at least one sales invoice, providing at least one customer having at least one sales invoice and at least one purchase invoice, producing an invoice chain by capturing and organizing the at least one sales invoice, and at least one of the at least one purchase invoice; and offsetting the at least one sales invoice of the seller with at least one sales invoice of the customer, at least one purchase invoice of the customer or a combination thereof.

Methods for resolving invoice obligations are disclosed that include: a) providing at least one sales invoice, wherein each sales invoice comprises a credit value, b) providing at least one purchase invoice, wherein each purchase invoice comprises a debit value, and c) offsetting at least part of the debit value of a purchase invoice with at least part of the credit value of a sales invoice.

Methods are also disclosed for resolving invoice obligations that include: a) providing at least one seller having at least one sales invoice, b) providing at least one customer having at least one sales invoice and at least one purchase invoice, wherein at least one of the at least one sales invoice and at least one of the at least one purchase invoice forms an invoice chain; and c) offsetting the at least one sales invoice of the seller with at least one sales invoice of the customer, at least one purchase invoice of the customer or a combination thereof.

Systems for resolving invoice obligations are disclosed that include: a) an executable code for intelligently determining an invoice chain comprising at least one purchase invoice having a debit value and at least one sales invoice having a credit value and offsetting the debit value with the credit value, b) a medium for executing the executable code, c) a display device, and d) an interaction tool for executing the executable code.

Additionally, software packages are described that include an executable code for intelligently determining an invoice chain comprising at least one purchase invoice having a debit value and at least one sales invoice having a credit value and offsetting the debit value with the credit value.

Also described are a centralized network apparatus for communicating, combining, matching, offsetting, netting and clearing millions of invoices, which includes the ability for forming invoice chains and netting them with full audit capability and the protection of participant data privacy.

### DETAILED DESCRIPTION

A new system and related methods have been produced to enable a seller to use its sales invoices' value instead of cash or financing, to pay or fulfill at least part of its obligation in its purchase invoices' value and settle many or all invoices, in order to reduce invoice discount costs, penalties, interest, the need to borrow or finance assets, payment times, and the number of outstanding invoices. This contemplated system will likely increase liquidity and buying power or a combination thereof. The novel systems and methods described herein also provide a faster cheaper and more efficient alternative to factoring, any traditional form of borrowing, bartering or financing of invoices and can exist alongside these other methods. An invoice may be of any form, electronic or paper based; a bill; a payment owed; a credit or debit commitment of any kind; or any form of agreement or payment obligation between seller and customer and/or any payor and payee. A sales invoice to a seller or payee is a purchase invoice to a customer or payor, where a sales invoice and its corresponding purchase invoice that is subject to offset based on a number of factors, including without limitation, have the amount, issuer, terms, dates due, dates issued, and payee.

Invoice resolution systems are disclosed that include: at least one sales invoice, wherein each sales invoice comprises a credit value, at least one purchase invoice, wherein each purchase invoice comprises a debit value, at least one database or repository stored on a medium for executing the executable code that collects the at least one sales invoice and the at least one purchase invoice; and an executable code for intelligently determining an invoice chain comprising at least one purchase invoice having a debit value and at least one separate sales invoice having a credit value and offsetting the debit value with the credit value.

Invoice resolution systems are also disclosed that include: at least one sales invoice, wherein each sales invoice comprises a credit value, at least one purchase invoice, wherein each purchase invoice comprises a debit value, at least one database stored on a network computer system that collects the at least one sales invoice and the at least one purchase invoice; and an executable code for intelligently sorting the at least one purchase invoice having a debit value and at least one separate sales invoice having a credit value to produce an invoice chain and offsetting the debit value with the credit value.

Methods for resolving invoice obligations include: providing at least one seller having at least one sales invoice, providing at least one customer having at least one sales invoice and at least one purchase invoice, producing an invoice chain by utilizing the at least one sales invoice and at least one of the at least one purchase invoice; and offsetting the at least one sales invoice of the seller with at least one sales invoice of the customer, at least one purchase invoice of the customer or a combination thereof. It should be understood and as will be described in detail herein, the sales invoice and purchase invoice comprise two separate invoices and not the payor and payee sides of one invoice.

Contemplated methods for resolving invoice obligations include: providing at least one seller having at least one sales invoice and at least one customer having at least one sales invoice and one purchase invoice, wherein the at least one seller invoice and the at least one customer invoice form an invoice chain; and offsetting amount value of the at least one sales invoice of the seller with amount value of the at least one sales invoice of the customer. An invoice chain may contain, among other things, a large number of sellers and customers, invoices, amounts, currencies, varying invoice due dates and issuance dates. An invoice may be part of one or more invoice chains. Since a chain may only offset partial amounts of a single invoice, an invoice amount may be cleared by one or more invoices or invoice chains at the same or separate times. An invoice amount may be partially or fully cleared through offsetting. The concept of resolving invoice obligations, as used or referred to herein, means fulfillment of an invoice obligation, payment or offsetting of invoice. As used herein, the term “offsetting” means the transfer of a credit value of one sales invoice to satisfy the debit value of a purchase invoice (such as netting the debit amount from the credit amount) without the need to make a cash, check or electronic funds transfer, barter, factor, borrow or any combination thereof. As used herein, credit value means an amount to be received on an invoice and debit value means an amount to be paid on an invoice.

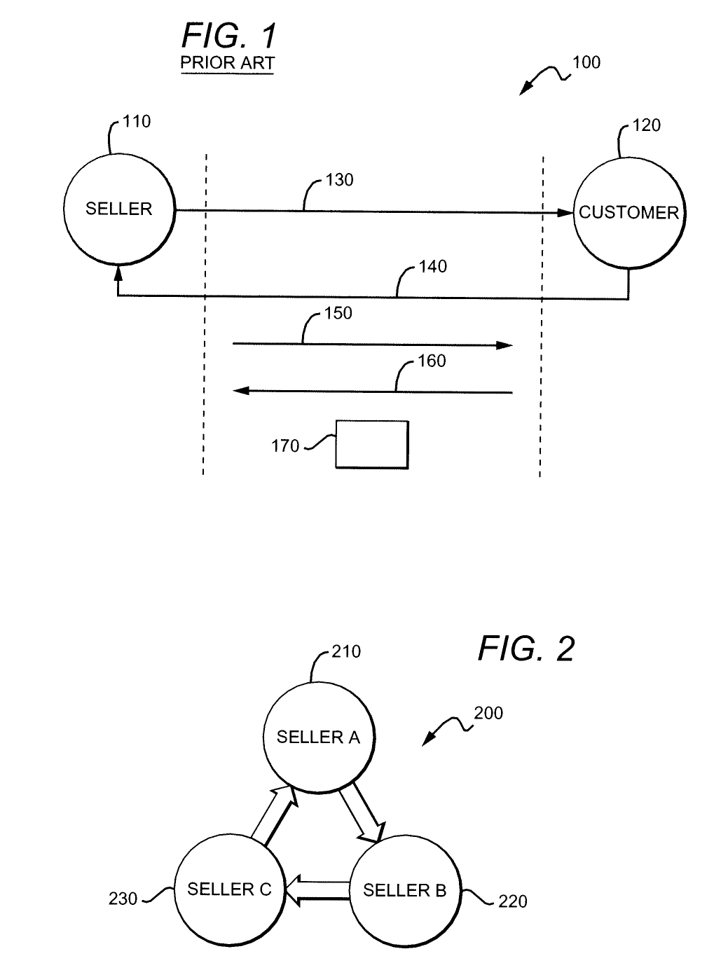

Specifically, electronic and/or automated fulfillment and settlement of obligations on invoices is achieved by matching and offsetting credit value amounts in sales invoices with debit value amounts in purchase invoices of a customer, through linking together sellers' invoices with customers' invoices. For example, a seller (seller A) issues an invoice (sales invoice) to a customer, that customer in turn is also a seller (seller B) who issues an invoice to its customer, who is also a seller (seller C) and so on, forming an implied tree and branches of linked sellers, customers and invoices, referred to here as an invoice chain or chain. In instances where the first seller in a chain is also a customer to another seller in the same invoice chain (“complete chain”), amounts in the linked invoices can be offset against each other (wherein the debit value of a customer's linked purchase invoice is offset by the credit value of its sales invoice(s) in the same chain), which is shown and described in detail later in FIG. 2. In some instances, a seller and/or customer may comprise a bank, a financial institution, a lending institution or another financial entity where they would have “invoices” in the form of loans, overdrafts, credits and other financial transactions.

All sellers are also customers in a complete chain. A “disparity chain” is an incomplete chain where the first or initial seller is not a customer in the same invoice chain and/or the last customer in the chain is not a seller in the same chain. Sellers who are also customers to other sellers in the same disparity chain can have their invoices offset and cleared in the same fashion as a complete chain, whereas an amount of the debit value purchase invoice of the last customer in the chain can be offset by an amount of the credit value of one or more of its sales invoices outside this chain; or be paid partially or fully in cash or in kind. Cash can be provided through a cash account, traditional sources, financing, or factoring of one or more of that customer's sales invoices. The remaining sellers in the disparity chain will be able to offset one or more of their purchase invoices in the same fashion as with the complete chain. The cash payment by the last customer in one disparity chain may also be a catalyst to a number of disparity chains. As used herein traditional sources means cash, check or electronic funds transfer, barter, factor, borrow or any combination thereof. Contemplated methods of accounting and transfer of credit in any form from one party in the chain to another can be made through automatic identification of the receiving party. For example, an incomplete chain can develop through a cash payment made by one customer in the chain to a seller in the chain, whereas that seller rather than receiving the cash, has his obligation through a purchase invoice offset by this payment automatically to a third seller and so on until the end of that chain. At the end of that chain, the last seller ends up with the cash in his account. This last seller was identified automatically and amounts transferred to his account also automatically.

Therefore, at least one sales invoice of a seller is matched with a purchase invoice of a customer and offset with at least one sales invoice of that customer. The sellers and customers may be in the system at the same time or may be matched as one or more sellers and/or customers enter the system. For example, a seller's invoice “sales invoice” may be held in the system for a period of time until a suitable invoice chain is formed by the system until it can be offset. In another example, sales invoices and purchase invoices from different sellers and customers may enter the system and be matched at the same time to form one or more offsetting invoice chains. The system automatically determines and picks the optimal or close to optimal starting points of first seller and/or first invoice in forming invoice chains. The system also automatically determines and forms the optimal or close to optimal invoice chain for offsetting. In determining the optimal or close to optimal starting point or invoice chain, the system bases its determination on its determined optimal conditions which may be adjusted from time to time. The system can also operate without optimization by picking first seller and/or first invoice and invoice chains randomly or first come first served or some other business decisions.

In cases of time or amount discrepancies between the seller and customer as outlined in the previous paragraph, the system allows for a bank or other third party to initiate an invoice chain through the payment of the obligation on behalf of the customer and replacement of the customer's obligation to the seller with one to the bank or the third party, which allows for faster transaction time, cheaper financing for the bank and/or third party providing the capital. This procedure is “market making” in the invoice chain system similar to other financial markets such as stock or bond markets.

As the number of sellers and invoices in the system increase, the complexity of forming chains increase with it exponentially. For example, a seller with five customers who have at least five customers may produce over ˜255 overlapping chains. On the other hand, 1,000 companies doing business together may produce ˜1 million overlapping chains. The method of automatically forming invoice chains out of millions of connected sellers, customers and invoices is described in here, including a method for determined optimal conditions.

As used herein, the phrase “determined optimal conditions” means the best conditions to determine the optimal or close to optimal chain, including the starting point, individual links, and ending point of invoice chains and the invoice chains to offset. This optimization process takes into consideration fixed and variable conditions of: a) priorities as determined by economic conditions and sellers satisfaction that the system can adjust or be adjusted to handle, for example, maximizing liquidity, fastest offsetting and clearing time vs. offsetting and clearing the highest amount per invoice (where the default may be the highest amount per invoice within a day); b) special conditions such as invoice terms, limited time discounts offered by sellers, seller limited choices of which purchase invoices they would like to offset first, bankruptcy laws, regulations, currency conversions and other factors; and c) computer limitations.

The systems and methods described herein are used to: a) obtain invoices (sales invoices and/or purchase invoices) or invoice information and authorization from sellers and customers (ideally obtaining all sales invoices from sellers and all purchase invoices from customers), b) match sales invoices with their corresponding purchase invoices; sellers and customers and build credit value and debit value chains of related invoices as invoice chains for offsetting and clearing, c) offset purchase invoice debits with sales invoice credits, report and manage post-processing matters.

One contemplated method determines if a seller (seller A) has issued a sales invoice to a customer, who is in turn also a seller (seller B), who has issued a sales invoice to a customer, who is in turn also a seller (seller C), and this process is continued until reaching a sales invoice that is issued to seller A. Once this second phase is complete, a chain of invoices is formed that starts with seller A (as a seller) and ends with the same seller A (as a customer). These invoices are then automatically offset or the results may be then presented to all of the sellers and customers in the chain where they can agree to offset their outstanding sales invoices with their outstanding purchase invoices in the chain. Sellers in the chain of invoices can be provided with a choice to either accept or reject offsetting the presented invoices manually or automatically through a set of computerized rules and programs designed to take advantage of and use contemporary technologies and formats.

In a contemplated system as shown in FIG. 3, the system 300, which may be referred to as Invoice Clearing System, is a computerized system that processes and offsets invoices as described herein. In this instance, sellers 310 and customers 320 put invoices into the system 330. The system requires that every sales invoice be matched 340 with its corresponding purchase invoice in the system in order to be included in the offsetting process. Some exceptions for insured or high credit quality sellers or customers may have their invoices included without matching. The optimal starting point and determined optimal conditions are determined in order to evaluate whether the invoice qualifies as a starting point to building an invoice chain. After classifying the invoice 350, it can then be made available to be included 360 in an invoice chain by the system 300. The system 300 will include the invoice in one or more chains until it becomes part of an optimal invoice chain 370. As used herein, the phrase “optimal invoice chain” means a chain that is determined to have the best economic value based on the determined optimal conditions. Once the invoice is part of an optimal invoice chain 370, it is offset with other invoices in the chain 380 and settled. The settlement will be reported to the seller and/or customer electronically and through other means as desired.

As shown, contemplated embodiments account for, among other things, different terms and due dates, currency denominations and/or legal rights related to the invoices in the invoice chain. Contemplated users may also conduct business within contemplated systems anonymously (through an anonymous identifier) or may be identified specifically. Contemplated systems may be extended to adapt to complex and/or modified compliance systems, to servicing lenders of sales invoices, factoring service providers, network providers, accounting systems, other computer applications and combinations thereof.

Some contemplated systems and methods described herein are used to:
1) Obtain invoices from sellers and customers by:
   sellers and customer communicating with the network.
   Invoices and invoice obligation information will be inputted in the system.
   Preferably, obtaining all sales and purchase invoices from sellers, and all purchase invoices from customers who are not sellers.
   Such other methods may be available from time to time
2) Match sales invoices with their corresponding purchase invoices; sellers and customers, build credit, and debit chains of related invoices as invoice chains for offsetting and clearing. The system:
   Automatically determines and picks the optimal or close to optimal starting point (“Optimal Starting Point”) to build an invoice chain or invoice chains. An Optimal Starting Point depends on the conditions or results defined and determined in the system's “Determined Optimal Conditions”. The system can also pick starting points of first invoice and seller in chains randomly or first come first served.)
   Build chains based on the Determined Optimal Conditions, which may include determining each link in the chain based on such Determined Optimal Conditions.
3) Offset purchase invoice debits with sales invoice credits incorporating interest discounts or debits as determined by interest parity by:
   Clearing and settling these invoices. May clear multiple chains simultaneously and amounts of an invoice balance may be cleared by more than one chain.
   Providing settlement confirmations and data to sellers and customers or their systems directly.

Specifically, FIG. 3 shows a block diagram for a contemplated system, where a contemplated workflow of invoices in a computer-based network environment and/or internet connection are described. In this diagram, a user (not shown) introduces an invoice into a contemplated system, where this introduction step may include a number of steps, such as initial registration, authorization, uploading information and/or inputting invoice information/data into the system manually or automatically through computer programs and networks, as described herein. Once the invoice is introduced into the system, the system will start the matching process as shown in 1 through 3 above.

If a chain match is found (meaning, an invoice is included in one or more formed invoice chains), the system determines the match amounts, any interest, terms and other aspects for clearance and in some cases presents them to the user for approval or automatically approves offsetting them. The system will also account for post processing issues, such as accounting methods, reporting and reprocessing the invoice's remaining balance in the system. The matched and offset amounts in the invoices are then fulfilled, settled and closed by the system. If no match is found, the invoice is maintained in the system's database or placed back into the system and reprocessed until a match in an invoice chain is found.

If the invoice is included in a disparity chain and the user's entity is the last customer in the chain, then the user may use another sales invoice outside the chain to offset the purchase invoice in the chain or the system may offer the user a premium from one or more of the sellers in the chain as an incentive for early payment or provide the user with a financing option, such as a no interest loan for the remaining term (until due date) of its outstanding purchase invoice. This process is automated with the user being able to set its financing options, terms and rates to automatically accepted levels or manually accept or reject them on a transactional basis.

If the invoice is found to be part of an incomplete invoice chain or disparity chain and the user's entity is the first seller in the chain then the system may allow the user to pay one or more of the user's outstanding purchase invoices; or amounts from the payment collected from the last customer in the chain; or factoring for the sales invoice in the chain; or a combination thereof. The factoring process may be automated with the user being able to set its options, terms and rates to automatically accepted levels or manually accept or reject them on a transactional basis.

Contemplated systems for resolving invoice obligations include: an executable code for intelligently determining an invoice chain comprising at least one sales invoice having a credit value and at least one separate purchase invoice having a debit value and offsetting an amount of the debit value of the purchase invoice with the credit value of the at least one sales invoice, a medium for executing the executable code, a display device, and an interaction tool for executing the executable code.

Contemplated system software can run on a computer and be connected to the Internet as well as to one or more internal and/or external networks, including among others direct line connections between two or more institutions, subsidiaries or governmental entities. In one embodiment, the system software can be structured as part of a network of servers running the databases with all invoice, sellers and customers for matching. In this embodiment, the server software will be multi-threaded and may be co-located in a number of geographic locations and accessed through the internet or non-internet based connections. The system software can also be used internally on private or corporate networks and/or computer systems.

The system is networked to allow sellers and customers with Internet or network access from anywhere to easily and quickly upload their sales and purchase invoice data, which also applies to users within a single organization with multiple subsidiaries or accounting offices. Users of the system can connect to it remotely through secure network connections and connections to their input interfaces (both manual and automated application interfaces).

Software packages are also disclosed that include an executable code for intelligently determining an invoice chain comprising at least one sales invoice and at least one purchase invoice and offsetting part or all of the debit amount of the at least one separate purchase invoice with the part or all of the credit amount of at least one sales invoice.

### Software Integration

Contemplated systems may integrate with a number of software solutions through an API and/or other conventional integration methods. One contemplated system can be built based on XML and/or the EDI (Electronic Data Interchange) framework and standards, which allows integration with the majority of electronic accounting and document exchange systems. Integration of these systems may include utilizing QuickBooks, Peachtree, SAP, Sage (Mas 90/Sage Mas 200, Accpac), Net Suite, Everest Software, Exact Financials, Oracle, Microsoft, Epicor and combinations thereof.

Communication

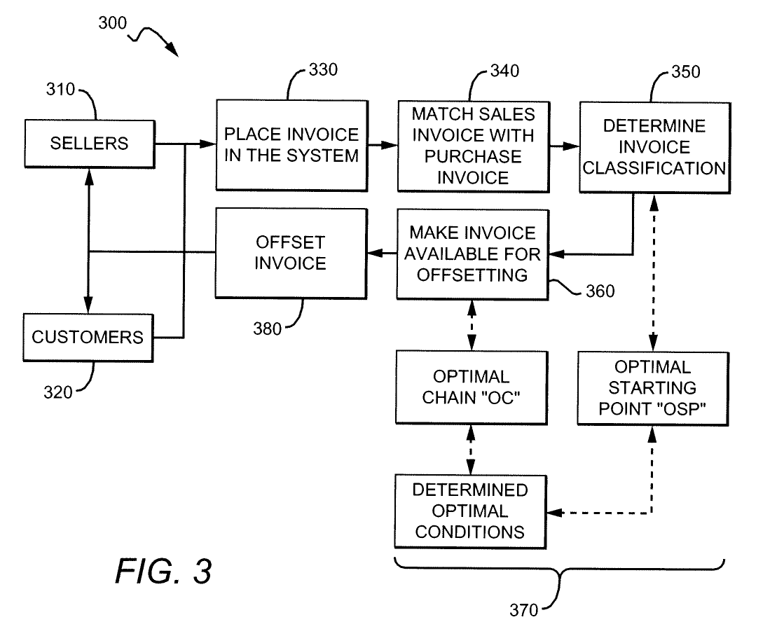

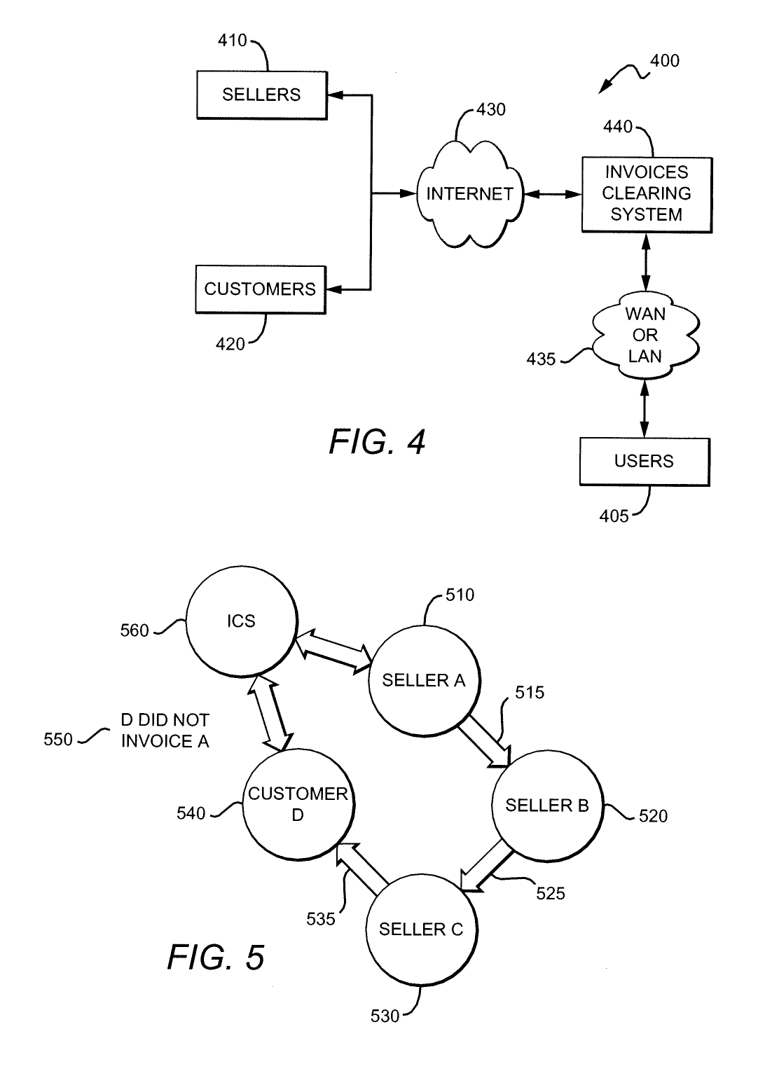

FIG. 4 shows some contemplated methods and systems 400 for users 405 (sellers 410 and customers 420) to connect and communicate with the invoice offsetting system. Specifically in FIG. 4, one contemplated embodiment includes the method where sellers 410 and customers 420 place invoices or invoice information (not shown) into an invoices clearing system 440 using Internet, WAN, LAN, FTP or other electronic communication methods 430 and 435; using integrated applications, including among others, accounting software, EDI implementations, XML or more. The submission of invoices or invoice information to the system may be done automatically or under special conditions initiated by an operator. The invoice clearing system data will also provide minimal communication of particular information contained on invoices or non-essential data. For example, the bank/operator and sellers may choose never to disclose any details about the invoice to the bank, other than the amount, due date, invoice term and number, which will allow the seller not to disclose any inventory changes, sales of particular items, discounts, credits for returned items, or anything that is not essential to the matching process.

Users and their systems or applications can connect, integrate and communicate with the invoice offsetting system, including among others:

EDI VAN & Internet Connection

Contemplated systems may integrate its services with EDI VAN providers to allow users to connect through their existing or modified accounts. EDI connections can be provided through:

Value Added Networks

In the most basic form, a Valued Added Network or “VAN” acts as a regional post office. They receive transactions, examine the ‘From’ and the ‘To’ information, and route the transaction to the final recipient. VANs provide a number of additional services, e.g. retransmitting documents, providing third party audit information, acting as a gateway for different transmission methods, and handling telecommunications support. Because of these and other services VANs provide, businesses frequently use a VAN even when both trading partners are using Internet-based protocols. Healthcare clearinghouses perform many of the same functions as a VAN, but have additional legal restrictions that govern protected healthcare information.

VANs also provide an advantage with certificate replacement in AS2 transmissions. Because each node in a traditionally business-related AS2 transmission usually involves a security certificate, routing a large number of partners through a VAN can make certificate replacement much easier.

Internet/AS2

Until recently, Internet transmissions were handled by nonstandard methods between trading partners usually involving FTP or email attachments. There are also standards for embedding EDI documents into XML. Many organizations are migrating to this protocol to reduce costs. For example, Wal-Mart is now requiring its trading partners to switch to the AS2 protocol.

AS2 (Applicability Statement 2) is the draft specification standard by which vendor applications communicate EDI or other business-to-business data (such as XML) over the Internet using HTTP, a standard used by the World Wide Web. AS2 provides security for the transport payload through digital signatures and data encryption, and ensures reliable, non-repudiable delivery through the use of receipts

VPN

Users may wish to connect to contemplated systems via a Virtual Private Network (VPN) over the Internet, utilizing the IP Security Protocol (IPSec).

Web SSL

Contemplated systems may provide SSL encryption directly through the Internet.

Cross-Connect

Contemplated systems may be hosted by other providers through hosted data centers.

Extranet

Contemplated systems may connect to several extranet providers, including BT-Radianz, TNSi, Yipes, and SAVVIS. These contemplated systems may connect to customers via any open and available extranet provider, based on subscriber demand and cooperation from the extranet provider.

Private Line

Some contemplated users may wish to initiate a private line (or point-to-point) connection to contemplated systems using leased lines or other network methods, such as Telco-provided T-1. T-3, Frame Relay, ATM and/or MetroE. These connections are terminated by a user-provided and owned router or switch in the contemplated system datacenter space.

The system may also integrate with intranets, extranets and internal networks of industries, institutions and more. The system may also integrate with future and new protocols and technologies that are not mentioned above or may come in the future.

As discussed in the background section, there are systems whereby a participant deposits a predetermined amount of money into a prefunded balance account and then plans and directs offsets by the participants to other specific and known participants. These offsets are on payments made and not invoices. They don't include chain invoice discovery, where the parties are assembled in an invoice chains, payments are from known parties to known parties (usually 40 banks). These offsets are not automatically generated on the basis of other considerations, and in fact, are linearly arranged using a method of aggregation. Current embodiments disclosed herein are peer-to-peer that do not use or need to use aggregation at a clearing institution or a substitution of counter-parties. In addition, current embodiments disclose and offer the ability to produce liquidity through early fulfillment of obligations and related interest, which is a significant benefit that is not obtained by netting cash against cash on a payment due and made in the same day. The Pawelczyk publication netting process offers efficiency and limits the need to move cash through the fed. Current embodiments of the subject application, on the other hand, provide early payment liquidity and the ability to increase capital flow in the economy (not just substitute it). Finally, the Pawelczyk systems match payor and payee through aggregation at the time of payment from cash or credit accounts. The current application finds relationships among invoices and not routing of cash payment or aggregation of cash payments through banks. This major difference allows the development of netting chains at a much lower level than Pawelczyk, allowing individual companies to benefit from early liquidity, reduced need for cash requirement for payments which cannot be achieved through the technical methods and capabilities of Pawelczyk. Additionally, current embodiments will allow the matching of invoices and payments among thousands or millions of participants, where as Pawelczyk system is limited to pyramid like aggregation among a few participants initiating cash payments at the same time (within the same 24 hours).

### EXAMPLES

### Example 1

### Simple Diagram of Invoice Offsetting System

One seller (seller A) issues a sales invoice for $1000 to a customer, who is also identified as seller B. Seller B has issued a different sales invoice for $1000 to its customer, who is in turn also a seller (seller C) who has issued a sales invoice for $1000 to a third customer—who, as it turns out, is seller A. The matching and offsetting can happen within seconds of posting all of these invoices in the system.

Contemplated systems are used to offset all of these sales invoices based on seller A's purchase invoice from seller C being offset by seller A's sales invoice to seller B, whose purchase invoice to seller A can be offset by its (seller B's) sales invoice to seller C, completing the offset of all invoices in the chain.

### Example 2

### Simple Diagram of Invoice Offsetting System 200 with Uneven Invoice Amounts (FIG. 2)

Seller A 210 issues a $1000 sales invoice to a customer, who is also, considered a seller (seller B) 220. Seller B 220 has issued a $1000 sales invoice to a customer, who is also considered a seller (seller C) 230. Seller C 230 has issued a $500 sales invoice to yet another customer, who is identified by the system as seller A 210.

The invoice chain can be utilized to offset $500 for each of these invoices and a new balance of the remaining amounts of the sales invoices issued by seller A 210 and seller B 220 for $500 each, and also results in the offsetting of the full amount of the invoice between seller C 230 and seller A 210.

### Example 3

### Invoice Clearing System Example for Factoring Businesses

Contemplated systems and methods described herein also provide a faster cheaper and more efficient alternative to factoring, short term borrowing or financing of invoices.

For example, while the seller's factoring, issuing short-term borrowing instruments or financing invoices may cost around 2%, 0.8% and 0.7% on average per 30-day period respectively, the seller's cost in the novel system may range between 0.325% to 0.55%. This saving is achieved because in the novel system and methods matches, offsets and settles amounts of the seller's purchase invoices with amount from its sales invoices. So, as the seller would be required to pay an interest (in this example, 0.7% to 2%) on its sales invoices comparable to financing, receivable discount, or factoring, it would automatically receive a lower but proportional interest on its purchase invoices (in this example, 0.7% to 1.65%). The novel system and methods provide a commercial medium for sellers to achieve their liquidity, buying power and reduced cost goals without the need for traditional financing, discounts or factoring methods and without their related costs. The amount of interest paid and received by the seller will depend on several factors which may include interest rate parity of an efficient financial market.

### Example 4

### Invoice Clearing System Example for Large Numbers of Sellers and/or Customers

An invoice chain may contain a large number of sellers and customers, invoices, amounts, currencies, varying invoice due dates and issuance dates. An optimum condition will include all sellers, customers, invoices, amounts, currencies and due and issue dates in the universe. In the contemplated methods an invoice can be part of one or more chains; an invoice amount may be cleared by one or more chains at the same or separate times; an invoice amount may be partially cleared; and an invoice may be part of one or more chain containing invoices of different terms, conditions, currencies and other variables common with invoices and methods of payment.

For example, a seller (Seller A) issues an invoice (sales invoice) to a customer, that customer in turn is also a seller (Seller B) who issues an invoice to another customer, who is also a seller (Seller C) who issues an invoice to Seller A. This forms a complete chain of invoices (“complete chain”) wherein Seller A's sales invoice to Seller B can be linked to Seller B's sales invoice to Seller C and Seller C's sales invoice to Seller A, which is also Seller A's purchase invoice. Therefore, an amount of Seller A's purchase invoice with Seller C can be offset by Seller A's sales invoice to Seller B; an amount of Seller B's purchase invoice with Seller A can be offset by Seller B's sales invoice to Seller C; and an amount of Seller C's purchase invoice with Seller B can be offset by Seller C's sales invoice to Seller A. In other words Seller C owes Seller B who owes Seller A who owes Seller C, so by linking these three sellers in a network, Seller C can automatically deduct an amount that Seller A owes it from the amount Seller C owes to Seller B and in turn Seller B and Seller A can do the same and an amount of all their invoices can be settled and satisfied.

### Example 5

### Invoice Clearing System Example Showing Concept of Incomplete or Disparity Chains

Many times and due to many factors, including among others, the number of sellers and or invoices in a network and their relationship to the total number of sellers and invoices in the world, or the times invoices are issued and certain conditions and variables of invoices, may cause a number of invoices in the system not to be offset through a complete invoice chain. The system will form links between sellers, their customers, their customers' customers and so on developing trees and branches of linked invoices. These linked invoices can be used by the system to form incomplete invoice chains “disparity chain”.

For example, a seller (Seller A) issues an invoice (sales invoice) to a customer, that customer in turn is also a seller (Seller B) who issues an invoice to another customer, who is also a seller (Seller C) who issues an invoice to another customer (Seller D) and so on, but no one in this chain issues an invoice to Seller A. This is an incomplete invoice chain, unlike the complete chain where the debit value of a purchase invoice can be offset by the credit value of sales invoice; this offsetting condition can only exist with additional actions by the system.

### Example 6

### Invoice Clearing System Example Showing Resolution of Incomplete Invoice Chains

Invoices in incomplete or disparity chains can be offset through different methods within the system depending on determined optimal conditions. One contemplated method of offsetting and settling these invoices is to allow the last customer in a chain to use one or more sales invoices outside the chain. Another contemplated method may allow the last customer to use conventional methods of financing a purchase order issued to it. Another contemplated method may allow the last customer to use conventional methods of financing or making a payment and keeping the interest premium from the paid purchase invoice in the same chain. These contemplated method's results can provide the first seller in the disparity chain with either a payment on its sales invoice in the chain or the ability to offset one or more of its other purchase invoices outside the chain. All sellers who are also customers in the disparity chain will have their invoices offset, cleared and settled in a similar fashion to a complete invoice chain.

For example as shown in FIG. 5, a seller (Seller A) 510 issues an invoice 515 (sales invoice) to a customer, that customer in turn is also a seller (Seller B) 520 who issues an invoice 525 to another customer, who is also a seller (Seller C) 530 who issues an invoice 535 to another customer (Customer D) 540, but no one in this chain issues an invoice 550 to Seller A. These invoices and invoice chain can be processed and intelligently optimized by utilizing a contemplated invoice clearing system 560. Customer D can use one or more sales invoices from outside this chain to offset its purchase invoice in the chain or one can factor the Seller A sales invoice and finance Customer D's purchase invoice at the same costs and creating similar conditions to a complete invoice chain. This contemplated method is among several methods in the system that provide significant solutions to optimizing the liquidity and value of the system even with the smallest number of sellers, allowing for a smaller percentage of sellers in a network to reach the critical mass of close to optimal economic benefits.

### Example 7

### Invoice Clearing System Example Showing Alternative Offsetting Method

Another contemplated method of method of offsetting and settling these invoices is to use the interest from the sales invoice of the first seller in the chain and the margin to be collected between what the other sellers in the chain pay and what they receive in interest or discounts, (if and when the invoices of the incomplete or disparity chain are offset), to provide a discount or interest to the last customer in the chain in order for the last customer in the chain to satisfy an amount of its purchase invoice in the chain. The last customer can choose to pay that amount and keep the interest or discount; or use the interest or discount to pay the interest on financing.

For example, a seller (Seller A) issues an invoice (sales invoice) to a customer, that customer in turn is also a seller (Seller B) who issues an invoice to another customer, who is also a seller (Seller C) who issues an invoice to another customer (Customer D), but no one in this chain issues an invoice to Seller A. One can use the amount of interest payable by the Seller A for the early payment of its sales invoice and the margin of difference between what sellers B and C pay on their own sales invoices and what they would receive on their purchase invoices if they're offset in the chain, to pay an amount of interest or discount to entice Customer D to pay or finance Customer D's purchase invoice in the chain.

### Example 8

### Invoice Clearing System Example Showing Optimization

The system automatically and/or through business rules determines and picks the optimal or close to optimal starting points of first seller and/or first invoice in forming chains. The system also automatically and/or through business rules determines and forms the optimal or close to optimal invoice chain for offsetting. In determining the optimal or close to optimal starting point or chain, the system depends on the determined optimal conditions. The system can also operate without optimization by picking first seller and/or first invoice and chains randomly or first come first served.

Although it may not become a factor in the future, dependency on current computer hardware computational powers at a certain point may limit the ability of the system to determine within a reasonable period the optimal starting point or optimal invoice chain to clear. In such a case, the system will instead determine the close to optimal point, such as a contemplated method of determining the optimal invoice chain by building chains starting with every sales invoice in the top 20% of sellers with the highest amounts of invoices and choosing to clear chains with the highest total invoice amounts cleared. Another contemplated method is to find the within 15% the top 20% of the most recurring invoice amounts in the system and start chains with every one of these invoices to find the chains with the highest amounts and most sellers to clear, regardless of whether it's a complete invoice chain or an incomplete chain.

Another contemplated method is to pick in random 20% of invoices submitted in a given day in the system as starting points and offset and clear all the chains built. Yet another contemplated method is to start an invoice chain with every new invoice submitted to the system and use its result for picking the close to optimal chain of the largest amount and secondarily the most invoices cleared. These and other contemplated methods depend on factors in the system such as the number of invoices and the number of sellers and customers to determine which is the best contemplated method for a computer to reach the closest optimal results within a reasonable time frame. For example, if there are 7 million invoices in the system, picking the optimal starting point is impractical on today's computers, picking the second contemplated method may result in up 80% of the desired results.

For example, one contemplated method of the system picks the optimal starting point based on the highest amount invoice in the network in order to maximize the amounts offset of invoices in a chain. This starting point will save considerable computing resources while achieving a certain level of liquidity and customer satisfaction. Another contemplated method picks the optimal starting point by identifying the top 20% of the invoices in the system with the most recurring invoice amount (within 10% margin of difference in the amounts) and building trees and branches of linked invoices from each of those top 20% of invoices to find the optimal or close to optimal chains to offset.

In another example, a complete chain of 100 invoices (Chain A) may offset and clear $700 per invoice or an average of 50% of the average invoice amount in the chain, but a chain of 77 invoices (Optimized Chain) including 70 of Chain A invoices may offset and clear $1,200 per invoice or an average of 80% of the average invoice amount in that chain. The system will disregard Chain A and offset invoices in the optimized chain that the system considers as closed to an optimal chain that Chain A.

### Example 9

### A Contemplated Method for Financial Institutions to Use Incomplete or Disparity Invoice Chain

Seller A issues an invoice (sales invoice) to a customer, that customer in turn is also a seller (Seller B) who issues an invoice to another customer, who is also a seller (Seller C) who issues an invoice to another customer (Customer D), but no one in this chain issues an invoice to Seller A. The system can automatically or through user transaction approval, factor the Seller A's sales invoice and finance Customer D's purchase invoice at the same costs and create similar conditions to a complete chain; or deliver a portion of the interest margin as incentive to customer to pay early as explained in disparity chain example.

The Invoice Clearing System (ICS) may be used to automatically purchase sales invoice (Factor) from Seller A at a discount. In another embodiment, one may offer Customer D the ability to use other sales invoice(s) to satisfy the obligations of its purchase invoice to Seller C automatically or get a free short-term interest loan. These two options are contemplated methods used by ICS in completing a disparity chain and can allow a financial institution to factor an invoice at its traditional rate and have it paid within minutes or a day by its loan to the last customer (Customer D). The financial institution will benefit from a significant increase in business and reduction in transaction and sales costs. The remaining invoices in a chain are offset in the same fashion as a complete invoice chain. ($500 Purchase Invoice debit with $500 Sales Invoice credit)

### Example 10

### Example of Contemplated Offsetting of Invoices in an Invoice Chain

Table 1 shows an example of a complete invoice chain.

TABLE 1
Complete invoice chain
Example date

| | | | | Seller | Seller | | | | | |
|---|---|---|---|---|---|---|---|---|---|---|
| | | | Seller | Interest | “Interest | Interest | | | | Seller |
| | | Invoice | Interest | to | Margin” | Discount | Cost | Remaining | | Credit |
| Seller | Customer | Amount | to pay | receive | or Cost | % | APR | Balance | Due Date | Rating |
| COMPANY A | COMPANY B | $50,000 | $328.60 | $84.00 | $244.60 | 0.51% | 6.00% | $2,000 | Jan. 21, 2008 | F |
| COMPANY B | COMPANY C | $250,000 | $182.00 | $93.00 | $89.00 | 0.19% | 2.60% | $202,000 | Jan. 16, 2008 | A |
| COMPANY C | COMPANY D | $80,000 | $147.00 | $78.00 | $69.00 | 0.14% | 2.50% | $32,000 | Jan. 11, 2008 | A |
| COMPANY D | COMPANY E | $48,000 | $106.00 | $63.00 | $43.00 | 0.09% | 3.27% | $- | Dec. 31, 2007 | C |
| COMPANY E | COMPANY F | $132,000 | $106.00 | $30.00 | $76.00 | 0.16% | 5.78% | $84,000 | Dec. 31, 2007 | C |
| COMPANY F | COMPANY G | $115,000 | $255.60 | $30.00 | $225.60 | 0.47% | 5.72% | $67,000 | Jan. 20, 2008 | B |
| COMPANY G | COMPANY A | $50,000 | $196.00 | $90.00 | $106.00 | 0.22% | 2.88% | $2,000 | Jan. 18, 2008 | A |
| Offset Amount | | $48,000 | | | | 0.25% | 4.11% | | | |

| | |
|---|---|
| Total Invoice Offset | $336,000 |

In this example, in this contemplated method of a complete chain, all the sellers are also customers in the same chain. An amount of $48,000 (“Offset Amount”) is determined as the smallest amount invoice and the highest amount that can be cleared in all invoices in the chain. Many sellers will have left over balances that become new outstanding balance amounts of these invoices and be processed again in the system without changing any of their terms.

The Interest Margin is the interest payable by a seller minus its interest receivable as a customer from another seller. The amount of interest paid and received by the seller will depend on several factors including interest rate parity with alternative financing and savings options, which includes credit worthiness; the time value from the offsetting date to the due date, and more.

Table 2 shows an example of an incomplete or “disparity” invoice chain.

TABLE 2
Incomplete invoice chain
Example date Dec. 21, 2007

| | | | | Seller | Seller | | | | | Seller |
|---|---|---|---|---|---|---|---|---|---|---|
| | | | Seller | Interest | “Interest | Interest | | | | Credit |
| | | Invoice | Interest | to | Margin” | Discount | Cost | Remaining | | Qualifier |
| Seller | Customer | Amount | to pay | receive | or Cost | % | APR | Balance | Due Date | Rating |
| COMPANY A | COMPANY B | $50,000 | $480.00 | | $328.60 | 1.00% | 11.77% | $2,000 | Jan. 21, 2008 | F |
| COMPANY B | COMPANY C | $250,000 | $182.00 | $93.00 | $89.00 | 0.19% | 2.60% | $202,000 | Jan. 16, 2008 | A |
| COMPANY C | COMPANY D | $80,000 | $147.00 | $78.00 | $69.00 | 0.14% | 2.50% | $32,000 | Jan. 11, 2008 | A |
| COMPANY D | COMPANY E | $48,000 | $106.00 | $63.00 | $43.00 | 0.09% | 3.27% | $- | Dec. 31, 2007 | C |
| COMPANY E | COMPANY F | $132,000 | $106.00 | $30.00 | $76.00 | 0.16% | 5.78% | $84,000 | Dec. 31, 2007 | C |
| COMPANY F | COMPANY G | $115,000 | $255.60 | $30.00 | $225.60 | 0.47% | 5.72% | $67,000 | Jan. 20, 2008 | B |
| COMPANY G | | | | $480.00 | ($480.00) | | | | | A |
| Offset Amount | | $48,000 | | | | 0.34% | 5.27% | | | |

| | |
|---|---|
| Total Invoice Offset | $288,000 |

In this example, not all the sellers are customers in the same chain. COMPANY A is a seller but not a customer in the chain and COMPANY G is a customer but not a seller in the chain. An amount of $48,000 (“Offset Amount”) is determined as the smallest amount invoice and the highest amount that can be cleared in all invoices in the chain (COMPANY A has a sales invoice but not a purchase invoice in the chain, while COMPANY G has a purchase invoice but not a sales invoice in the chain. The chain is cleared by incentivizing COMPANY G to pay COMPANY F $48,000 for a discount of $480 or 1%.

### Example 11

### One Example of an Interbank Relationship

One advantage of utilizing contemplated embodiments disclosed herein with respect to interbank payments is credit exposure. Whereas a situation like the economic crisis of 2007 through 2009 or the insolvency of ING due to their rogue trader's losses, may cause one of the 20 clearing banks utilizing cash to cash netting to be operating and clearing these payments for thousands of bank accounts while being insolvent or not having enough credit assets which without interference from governmental entities, such as the Federal Reserve and TARP would have wiped out millions of funded accounts and defaulted on billions of dollars in daily overdraft Using contemplated embodiments of resolving invoice obligations, the collapse of such entity will not have affected the netting and resolution process and would have saved billions in capital infusion from government and related losses.

### Example 12

### One Example of a Contemplated Code & A Design Approach for an Invoice Clearing System

The problem is being decomposed to a reversed “Traveling Salesman” problem (TSP). TSP attempts to find the shortest/least expensive route to visit each city along a route, where expense is defined by some factor/variable. In its basic form, a contemplated invoice clearing system does the reverse and attempts to find the most expensive route.

### Core Stages

1) Participant sellers and customers input their invoice data through one or more interfaces to the ICS, including web, API, EDI or third party providers of services. The ICS interfaces provide the ability to choose from manual all the way to fully automated and integrated data input.
2) The data and invoices are ranker and sorted according to the business rules and priorities, then provided to the ICS core matching system
3) The core matching engine will find the connections, paths of invoice credit and debit chains and allow the netting process to occur based on the optimal determined path rules and the business rules.
4) The matched chains are then netted and netting is reported to the sellers, customers and banking institutions (or operators). The netting process is automatically updated with payments made with cash, withdrawal of invoices, corrections and operator rejections.
5) The matching process continues based on the business and optimal determined path rules, every time new invoices, any cash payment or other events
   Below is pseudo code showing implementation details and selected slices of implemented Java code

```
Function void Run ( )
  List inv = PrepareInvoiceList ( ) ;
  Graph grp = MakeInvoiceGraph (inv) ;
  List trees = GenerateTrees (grp) ;
EndFunction
/ /-------------------------------------------
/ /Pseudo Code
Function List PrepareInvoiceList ( )
  List rawInvoices = ReadDatabase;
  List invoices;
  forEach rawInvoice in rawInvoices
    Var invoice = Fingerprint (rawInvoice) ;
    AddToList (invoices, invoice) ;
  endforEach
  return invoices;
EndFunction
/ /Actual Code
  private static ArrayList getInvoiceList (ResultSet
readInvoice)
  {
    / / TODO Auto-generated method stub
    Invoice i ;
    ArrayList al = new ArrayList ( ) ;
    try
    {
      while (readInvoice.next ( ) )
      {
        i = new Invoice ( ) ;
  i.setPayor (readInvoice.getString (2) ) ;
  i.setPayee (readInvoice.getString (3) ) ;
  i.setInvoiceNumber (readInvoice.getString (4) ) ;
  i.setPayDate (readInvoice.getDate (5) ) ;
  i.setIssueDate (readInvoice.getDate (6) ) ;
  i.setUploadDate (readInvoice.getDate (7) ) ;
        i.setAmount (readInvoice.getLong (8) ) ;
        al.add (i) ;
      }
    } catch (SQLException e) {
      / / TODO Auto-generated catch block
      e.printStackTrace ( ) ;
    }
    return al ;
  }
/ /-------------------------------------------
/ /Pseudo Code
Function Graph MakeInvoiceGraph (list invoices)
  Graph relations;
  forEach invoice in invoices
    Var payee = invoice.payee;
    if GraphContains (relations, payee)
    then
      AddToGraph (relations, invoice) ;
    else
      AddPayee (relations, payee) ;
      AddToGraph (relations, invoice) ;
    endif
  endforEach
  return relations;
EndFunction
/ /Actual Code
  private InvoiceGraph buildGraph (ArrayList
invoiceList)
  {
    InvoiceGraph ig = new InvoiceGraph ( ) ;
    Iterator i = invoiceList.iterator ( ) ;
    GraphNode gn;
    String payee;
    String val;
    while (i.hasNext ( ) )
    {
      gn = new GraphNode ( (Invoice) i.next ( ) ) ;
      payee = gn.getPayee ( ) ;
      / /check if payee added to hinge
      if ( !ig.contains (payee) ) / / if not add to
hinge
      {
        ig.addHingeNode (payee) ;
      }
      / /add to leaf
      ig.addNode (gn) ;
    }
    return ig;
/ /-------------------------------------------
/ /Pseudo Code
Function List GenerateTrees (Graph relations)
  List subroutes;
  List rules;
  Var tree = GetTreeRoot (relations, rules) ;
  while root isNotEmpty
  do
    GetTree (relations, rules, tree) ;
    AddToList (subroutes, tree) ;
    root = GetTreeRoot (relations, rules) ;
  endwhile
  return subroutes;
EndFunction
/ /-------------------------------------------
/ /Pseudo Code
Function Var GetTreeRoot (Graph relations, List rules)
  forEach rule in rules
    ApplyRule (relations, rule) ;
  endforEach
  return relations.nextnode;
EndFunction
/ /-------------------------------------------
/ /Pseudo Code
Function void GetTree (Graph relations, List rules, Var
root)
  while root.payors isNotEmpty
  do
    forEach rule in rules
      ApplyRuleToPayee (relations, rule,
root.payee) ;
    endforEach
    Var nextnode = relations.nextnode ;
    if nextnode isEmpty
    then
      return
    else
      AddToTree (root, nextnode) ;
      GetTree (relations, rules, nextnode) ;
    endif
  endwhile
EndFunction
/ /Actual Code
  private void buildSubTree (HingeNode hnode,
InvoiceTree it, InvoiceGraph ig)
  {
    GraphNode gn = null;
    HingeNode hn = null;
    while ( !hnode.processed ( ) )
    {
  if (Integer.parseInt (ig.peekNextHighToLow (hnode) .g
etAmount ( ) ) <
  Integer.parseInt (it.getCurrent ( ) .getAsGraphNode ( )
.getAmount ( ) ) )
      {
        gn = ig.getNextHighToLow (hnode) ;
        hn = ig.getHingeNode (gn.getPayor ( ) ) ;
        it.addNode (gn) ;
        numprocessed++;
        if (hn != null)
        {
          treedepth++;
          if (maxtreedepth <= treedepth)
          {
            maxtreedepth = treedepth;
          }
          buildSubTree (hn, it, ig) ;
          treedepth--;
        }
        it.reverse ( ) ;
      }
      else return;
    }
  }
```

### Example 13

### Contemplation of an Incomplete Chain with a Cash Payment And Bank Benefits

Companies (sellers and customers) input their invoices into the invoice clearing system, which is a contemplated system as disclosed herein, or “ICS” through automated network applications, such as connectors to their accounting systems or through a web interface to the ICS. Such information will only require the basic data of the invoices and will not be disclosed to any party unless required for the matching in a chain.

Once invoice data is inputted in the ICS, the ICS will find and determine connections among the companies and build complete and incomplete invoice chains of debtors and creditors.

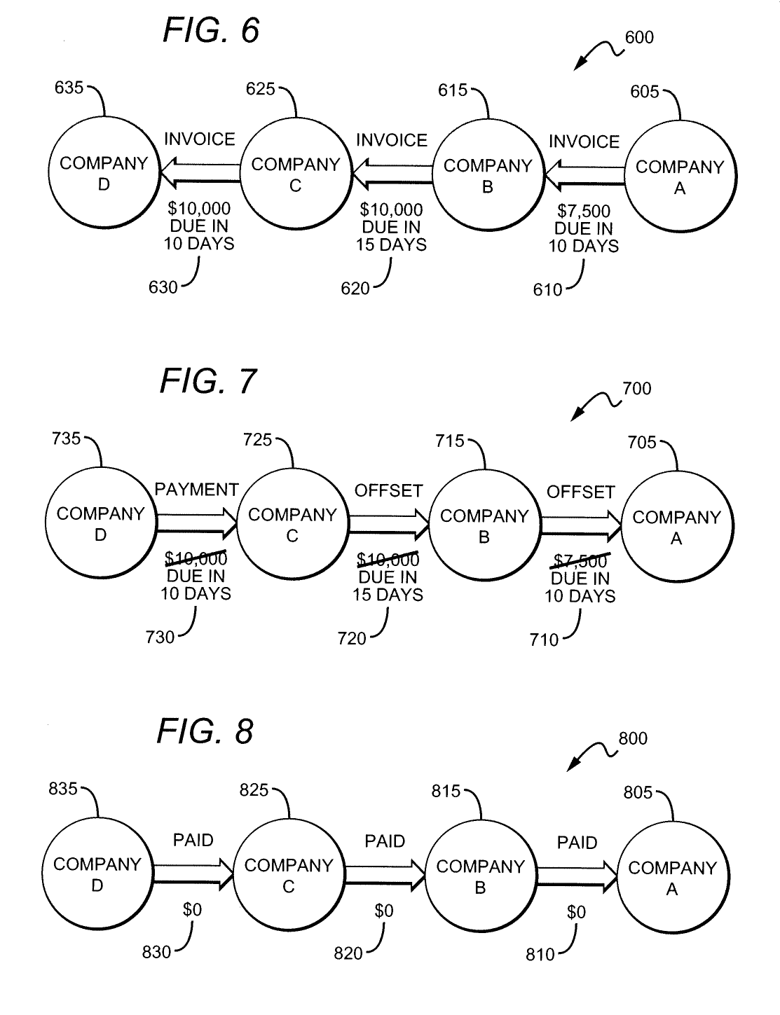

FIG. 6 shows an example of an incomplete chain 600 with 10 sellers and customers (i.e. “Company A” through customer “Company J”) and a cash payment made by the forth customer (in this chain the fourth customer is the same as the sixth seller, “Company D”). Once the cash payment is initiated the incomplete chain is automatically divided into two incomplete chains. One chain will comprise of Companies A through D (shown as 605, 615, 625 and 635) and another of Companies E through J (not shown). The reason for the division is the cash payment by Company D, which can be used to clear and net invoices of its vendors with no direct benefit from the payment to netting other invoices in the chain.

This example shows that Company D 635 owes $10,000 630 to Company C 625 on an invoice in this chain due in 10 days for which it is making the cash payment, whereas Company C 625 owes Company B 615 $10,000 620 due in 15 days on an invoice in the ICS. Additionally, Company B 615 owes $7,500 610 to Company A 605 in this chain due in 10 days from today.

For each day of early payment there is a benefit of cost of capital and liquidity received by the payee. Such benefits may include the reduction in the need to finance at a higher interest and cost or the need to have cash reserves to pay bills due on the same or earlier date than the payment received or to avoid paying late fees or credit risk with its own vendors for not paying on time. For all these and other benefits there is an interest component to the ICS netting that will compensate the payor for making an early payment.

In this example, payors receive interest¹ on their payments (e.g. 3.5% APR²), Receivers pay interest on the amounts they receive early (e.g. 7.5% APR²). The discrepancy between the amounts paid by the Receiver and received by the payor is an example of fees and interest collected by a bank or ICS operator for facilitating the transaction. These operators and banks will determine such fees, as they see fit for the value proposition to their ICS users. 1 Not a supplier discount.2 Rates determined by the bank.

The interest is paid and collected on the net days outstanding in the netting process. In this example, Company B is paying interest on net 5 days, the difference between its sales invoice due date (15 days) and its purchase invoice due date (10 days).

As shown in FIG. 7, the flow 700 of payments and netting is as follows (shown in Table 3):

| | Company D 735 | Company C 725 | Company B 715 | Company A 705 |
|---|---|---|---|---|
| Net Amount | Makes $10,000 cash | System auto offsets | System auto offsets $7,500 | Receives $7,500 in cash |
| | payment through the | $10,000 in invoices - 720 | in invoices and receives | from the system 710 |
| | system 730 | a payable to C with a | $2,500 in cash 710 | |
| | | receivable from A | | |
| Participant | Earn 3.5% APR interest on | Earn 3.5% APR interest on | Low cost financing at 7.5% | Low cost financing at 7.5% |
| Incentives | the cash payment for 10 | the netted amount for 5 | APR interest for 5 days¹ | APR interest for 10 days |
| | days | days | | |
| Alternatives | Earn 0.5% APR interest on | Earn little to zero interest on | Borrow against the | Borrow against the |
| | T-Bill/Savings for 10 days | cash reserves for payments | receivable from B to pay D - | receivable from C - less |
| | | (assuming A paid on time) | less proceeds available | proceeds available (80-85%) |
| | | | (80-85%) and at a higher | and at a higher cost |
| | | | cost | |

¹Also includes interest income on $2,500 for 15 days.

Therefore, the amounts shown in FIG. 8 for Companies (805, 815, 825 and 835) are all cleared 800 with different recipients of cash and offsetting payments (810, 820, 830). The bank and operate of the ICS will also benefit from generating fees and reducing traditional financing costs and exposure. Table 4 illustrates some of the benefits to the ICS operator bank.

| | Company A | Company B | Company C | Company D |
|---|---|---|---|---|
| Net | Makes $10,000 cash | System auto offsets | System auto offsets | Receives $7,500 in |
| Amount | payment through the system | $10,000 in invoices - | $7,500 in invoices and | cash from the |
| | | a payable to C with a | receives $2,500 in cash | system |
| | | receivable from A | | |
| Participant | Earn 3.5% APR interest | Earn 3.5% APR interest | Low cost financing at | Low cost financing |
| Incentives | on the cash payment for | on the netted amount for 5 | 7.5% APR interest for 5 | at 7.5% APR |
| | 10 days | days | days¹ | interest for 10 days |

| | | | |
|---|---|---|---|
| Bank | Provides business customers such as A with a higher return | Earns 7.5% APR interest for | Earns 7.5% |
| Benefits | on its cash. Provides B with a synthetic loan without | 5 days on $7,500, and for 15 | APR interest for |
| | actually risking its own capital. This also tremendously | days on $2,500 with no | 10 days on |
| | reduces the need to qualify customers for funding on each | capital risk | $7,500 with no |
| | invoice or month working capital balance. It eliminates the | | capital risk |
| | need for paper invoices and paperprocessing, faxing and | | |
| | telephone calls. | | |

The parties in the ICS benefit from added liquidity, reduction in financing cost and credit exposure, while significantly improving their efficiency over conventional methods of payment and invoicing. For example, the process above replaces the need to exchange any paper invoices or provide paperwork, fax new invoices or balance sheet letters for a financing bank or factor to approve. It did not require the use of telephones and prefunding qualification for the transaction by the bank.

Thus, specific embodiments and applications of methods, systems and software for offsetting invoice obligations have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

I claim:

1. An invoice resolution system, comprising:
at least one sales invoice, wherein each sales invoice comprises a credit value,
at least one purchase invoice, wherein each purchase invoice comprises a debit value,
at least one database or repository stored on a medium for executing the executable code that collects the information for the at least one sales invoice and the at least one purchase invoice; and
an executable code for intelligently determining an invoice chain comprising at least one purchase invoice having a debit value and at least one sales invoice having a credit value and offsetting the debit value with the credit value to form an offset value.

2. The system of claim 1, wherein the medium for executing the executable code comprises a computer processor, a server system, a network system, a web-based system, the internet or a combination thereof.

3. The system of claim 1, wherein the invoice chain is a complete chain.

4. The system of claim 1, wherein the invoice chain is a disparity or incomplete chain.

5. The system of claim 1, wherein at least one determined optimal condition is utilized to determine an optimal starting point for the invoice chain.

6. The system of claim 1, wherein the invoice chain comprises an optimal invoice chain.

7. The system of claim 1, wherein at least one of the at least one sales invoice is provided by a seller, a customer or a combination thereof.

8. The system of claim 1, wherein at least one of the at least one purchase invoice is provided by a customer.

9. The system of claim 1, wherein the offset value is zero.

10. The system of claim 1, wherein the offset value is greater than zero.

11. The system of claim 1, wherein the at least one sales invoice, the at least one credit invoice or a combination thereof is in electronic form.

12. An invoice resolution system, comprising:
at least one sales invoice, wherein each sales invoice comprises a credit value,
at least one purchase invoice, wherein each purchase invoice comprises a debit value,
at least one database stored on a network computer system that collects the at least one sales invoice and the at least one purchase invoice; and
an executable code for intelligently sorting the at least one purchase invoice having a debit value and at least one sales invoice having a credit value to produce an invoice chain and offsetting the debit value with the credit value.

13. A method for resolving invoice obligations, comprising
providing at least one seller having at least one sales invoice,
providing at least one customer having at least one sales invoice and at least one purchase invoice,
producing an invoice chain by utilizing the at least one sales invoice and at least one of the at least one purchase invoice; and
offsetting the at least one sales invoice of the seller with at least one sales invoice of the customer, at least one purchase invoice or a combination thereof to produce an offset value.

14. The method of claim 13, wherein the invoice chain is a complete chain.

15. The method of claim 13, wherein the invoice chain is a disparity chain.

16. The method of claim 13, wherein at least one determined optimal condition is utilized to determine an optimal starting point for the invoice chain.

17. The method of claim 13, wherein the invoice chain comprises an optimal invoice chain.

18. The method of claim 13, wherein the offset value is zero.

19. The method of claim 13, wherein the offset value is greater than zero.

20. The method of claim 13, wherein the at least one sales invoice, the at least one credit invoice or a combination thereof is in electronic form.
